(19) United States
(12) Patent Application Publication
(10) Pub. No.: US 2019/0033621 A1
(43) Pub. Date: Jan. 31, 2019

(54) Embellishment accessory for eyeglasses

(71) Applicant: Michelle Lynn Chrysler, Farmington Hills, MI (US)

(72) Inventor: Michelle Lynn Chrysler, Farmington Hills, MI (US)

(21) Appl. No.: 16/042,691

(22) Filed: Jul. 23, 2018

Related U.S. Application Data
(60) Provisional application No. 62/538,733, filed on Jul. 30, 2017.

(51) Int. Cl. G02C 11/02

(52) U.S. Cl. CPC G02C 11/02; G02C 2200/20

(57) ABSTRACT

The disclosure defined by this invention provides a method for an attachable and removable embellishment accessory for eyeglasses. The accessory encompasses a slender non-obtrusive “U” shaped embodiment with tractability and provides a thin protective and gripping layer between accessory and eyeglasses. The accessory is mounted on and off multiple eyeglass locations by hand. The outwardly facing side flat surface location enables a variety of embellishment shapes and sizes and is accommodating to materials commonly used in jewelry such as metals, stones, enamels and likewise. The curved or hinged inwardly facing side provides a universal and secure fit to a broad range of shape and size temples, rims, lens and end pieces of existing eyewear.

### CROSS-REFERENCE TO RELATED APPLICATIONS

This application claims benefit of U.S. Patent Provisional Application No. 62/538,733 filed Jul. 30, 2017.

### FIELD OF INVENTION

This present invention is in the field of eyeglass accessories. More specifically, this invention relates to an ornamental device for attaching to eyeglasses for the purpose of accessorizing eyewear in a manner closely resembling an article of jewelry.

### BACKGROUND OF THE INVENTION

There are three primary categories that this present invention relates to; eyeglasses, embellishments and jewelry. Eyeglasses are a device to compensate for defective vision or to protect the eyes from light, dust, and the like. Eyeglasses are, generally speaking, a utility. However, in the recent years, eyeglasses are also worn for fashion purposes. An embellishment is a decorative detail or feature added to something to make it more attractive. Jewelry is typically known as articles of gold, silver, other metals, precious and semi-precious stones, beads and likewise worn for personal adornment.

Related art teaches a long-felt desire to enhance or change the appearance of one's eyewear. However, to date, none of which encompasses of all the necessary and desirable features thereof.

### SUMMARY AND PURPOSE OF THE INVENTION

Whether worn as a necessity or for fashion purposes, eyeglasses of all sorts are more and more becoming a means for men, women and children to individualize themselves based upon style, color, shapes and ornamental features in the eyewear. For most individuals, it is impractical or not feasible to purchase multiple pairs of eyeglasses to change his/her appearance routinely.

It is highly desirable that an ornamental accessory for eyeglasses provides all of the aspects required to fulfill a satisfactory manner for embellishing eyewear, including: 1.) a single embodiment accommodating varying frame shapes and sizes, 2.) ease of attaching and detaching, 3.) slender and non-invasive attaching apparatus, 4.) secure hold to eyeglasses, 5.) lightweight and 6.) protection from scratching or otherwise damaging to eyeglasses.

This present invention enables eyeglass wearers to change the appearance of his and her eyeglasses in an aesthetically appealing manner by means of exchangeable and removeable embellishments configured universally to fit temples, rims, lens and end pieces of existing eyewear, as the wearer so desires. In this invention, the accessory for eyeglasses comprises of materials commonly used in articles of jewelry, such as silver, gold, steel and other metals, natural and synthetic stones, beads, leather, enamel, plastic and likewise materials. The slender design is lightweight and non-obtrusive whereby accommodating both small and large adornments. The accessory provides scratch protection and will easily and securely slide on, push on, grip on or clip on to eyeglass frames, hereby providing eyeglass wearers with a vogue, chic and sophisticated manner for accessorizing his or her eyeglasses.

### BRIEF DESCRIPTION OF DRAWINGS

FIG. 1A illustrates side view of first embodiment of attaching apparatus of this present invention.

FIG. 1B illustrates perspective view of first embodiment with inner protective coating.

FIG. 1C illustrates perspective view of first embodiment.

FIG. 2 illustrates perspective view of a second embodiment of attaching apparatus with spring or tension hinge.

FIG. 3 illustrates perspective side view of first embodiment while in use on or around eyeglass temple.

FIG. 4 illustrates first embodiment of this present invention in use on eyeglass temple from inwardly facing side.

FIG. 5 illustrates first embodiment of this invention with embellishment in use while on eyeglass temple from outwardly facing side.

FIG. 6 illustrates first embodiment with embellishment while in use on eyeglass rim and lens.

FIG. 7 illustrates first embodiment with embellishment while in use on eyeglass rim and lens from outwardly facing side.

### DETAILED DESCRIPTION OF THE INVENTION AND EXEMPLARY EMBODIMENTS

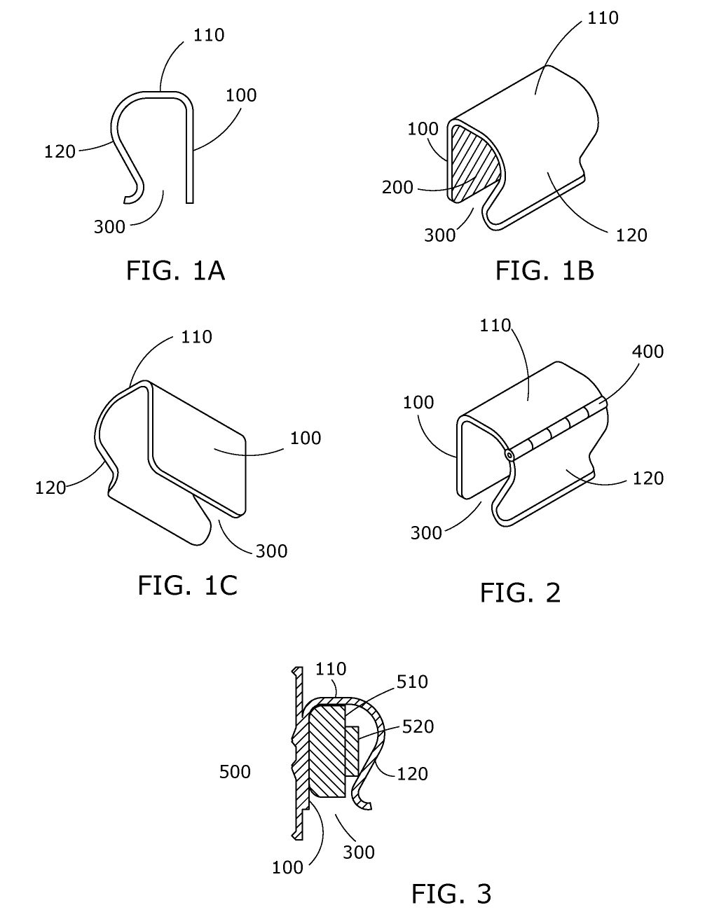

FIGS. 1A-C illustrate the first embodiment configuration in this present invention wherein the attaching device easily slides on or pushes on to the temples, rims, lens and end pieces of eyewear. This particular embodiment comprises a material with adequate tensile strength, preferably a metal, providing for expansion and contraction as the device is moved on and off eyewear, enabling a snug and secure fit to the eyeglasses until forcibly removed by the wearer.

FIG. 1A illustrates an outwardly facing surface 100 comprising an embellishment or designated location for embellishment and is contiguous and perpendicular to a top side 110, or reversibly, a bottom side 110. Also contiguous and perpendicular to the top side 110 is an inwardly facing side 120 comprising of a curve, or an “S” curve 120, providing for secure hold to multiple locations of choice of eyewear frames. An embellishment will preferably be affixed to the designated location for embellishment 100 during the manufacturing or assembly process. Eyeglass component will insert within open side 300.

FIG. 1B illustrates perspective view of attaching embodiment with the addition of a thin inner coating 200 comprising of rubber or any other substance suitable for providing grip and scratch resistance to the eyewear. Also illustrated is the outwardly facing side 100, top or bottom side 110, inwardly facing side 120, and open side 300, wherein accessory can be mounted to eyeglass component of choice.

FIG. 1C illustrates another perspective view of attaching embodiment. The three-sided embodiment is configured to mount on, over or around eyeglass frames by inserting eyeglass frame component of choice at open side 300. Also illustrated is outwardly facing side 100, top or bottom side 110, inwardly facing side 120.

FIG. 2 illustrates a second embodiment similar to that shown in FIGS. 1A through 1C with the addition of a spring hinge 400 or tension hinge 400 running along the inwardly facing side 120 or adjoining the inwardly facing side 120 to the top or bottom side 110. Wearer will push up on hinged section of inwardly facing side 120 to place on, over or around eyewear then release hinge for secure grip to frame. It is preferred that this embodiment also comprises a curve or “S” curve on inwardly facing side 120 to adequately accommodate varying frame sizes and temple hinges. This embodiment may also comprise of an inner coating 200 as illustrated in FIG. 1B.

FIG. 3 illustrates a cross sectional view of embodiment with embellishment 500 in use on eyeglass temple 510 with eyeglass temple 510 comprising of temple hinge 520, whereby easily overcoming the invasive temple hinge 520 and further depicting accommodation to temples without exterior hinges, as well as other frame components. Also illustrated is an outwardly facing side 100, top or bottom side 110, inwardly facing side 120 and opening for mounting to eyewear 300. In this particular embodiment, the embellishment 500 is larger than the attaching device itself, however, as in all cases, the accessory in this present invention accommodates a wide range of embellishment shapes and sizes.

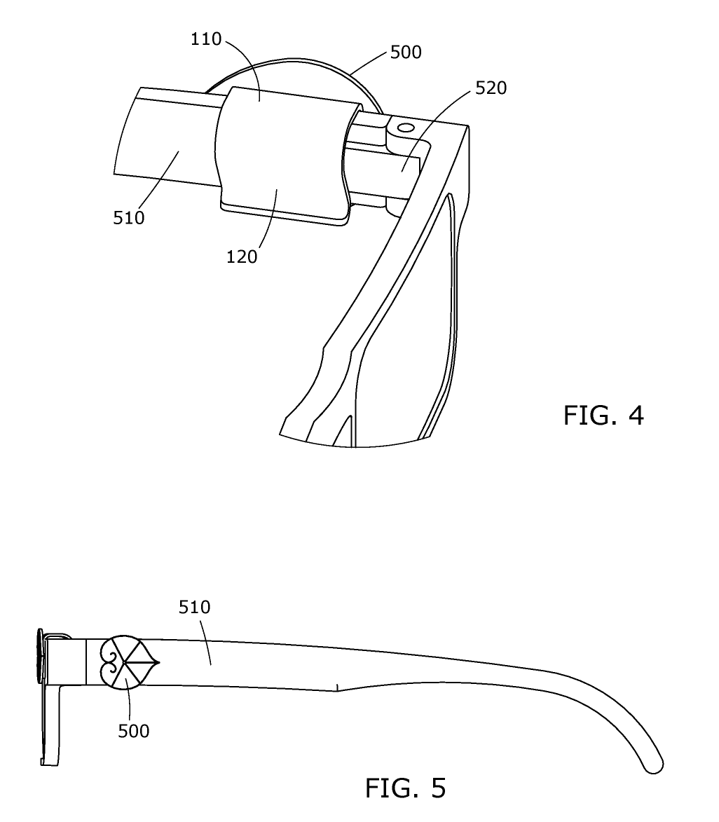

FIG. 4 illustrates inwardly facing side 120 and top side 110 of attaching device shown in FIGS. 1A through 1C with embellishment 500 in use on eyeglass temple 510 and eyeglass temple 510 comprising temple hinge 520, as also illustrated in FIG. 3.

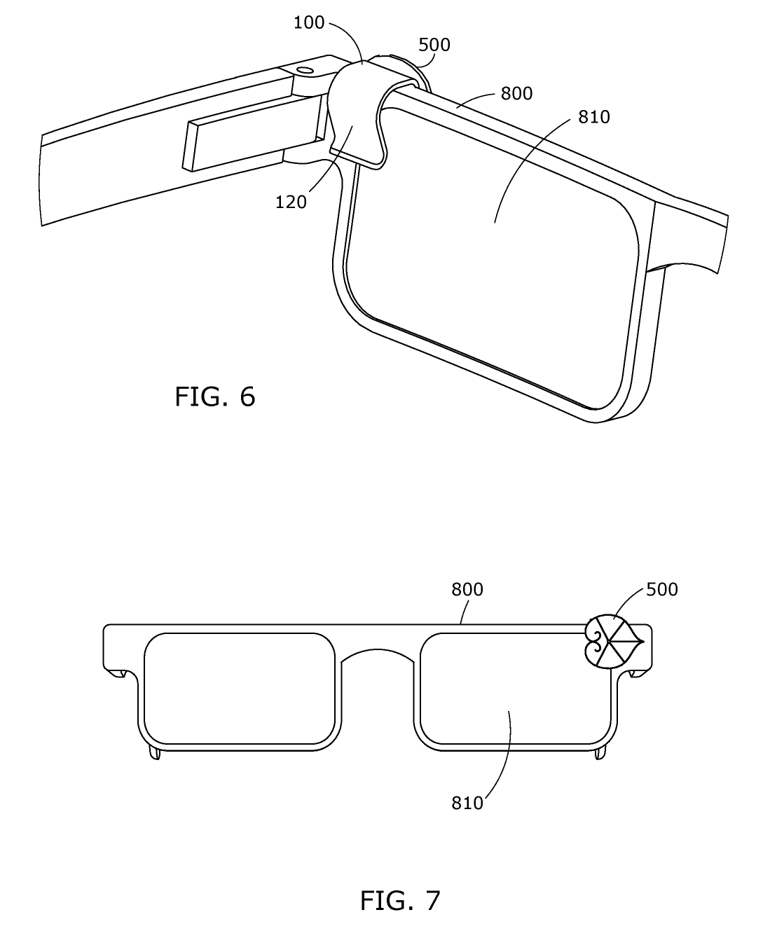

FIG. 5 illustrates appearance of attaching device illustrated in FIG. 3 in use on eyeglass temple 510 with the outwardly facing side 100 comprising embellishment 500.

FIG. 6 illustrates inwardly facing side 120 and top side 100 of attaching device shown in FIGS. 1A-1C with embellishment 500 in use on eyeglass rim 800 and in contact with lens 810.

FIG. 7 illustrates outwardly facing side 100 of attaching device with embellishment 500 shown in FIGS. 1A-1C with embellishment 500 in use on eyeglass rim 800 and in contact lens 810.

The embellishments and core embodiments of said attaching apparatus may vary in shape, size, dimension and ornamental features. Drawings are for illustrative purposes only.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment(s) without departing from the broad inventive concepts of the invention. It is understood therefore that the invention is not limited to the particular embodiments which are described but is intended to cover all modifications and changes within the scope and spirit of the invention.

1. An accessory for attaching on, over or around temples, rims, end pieces or lens of eyeglasses, comprising:
a.) a first-side member of core embodiment, preferably and referred to as outwardly facing side, comprising of an embellishment or designated location for an embellishment, and
b.) a second-side member of core embodiment, preferably and referred to as top side, or reversely bottom side, contiguous and perpendicular to the outwardly facing side of the core embodiment, and
c.) a third-side member of core embodiment, preferably and referred to as inwardly facing side of the core embodiment, contiguous and perpendicular to the top side, wherein together with (b.) top or bottom side and (a.) outwardly facing side, embodiment substantially resembles a “U” shape.

2. An accessory for attaching on, over or around temples, rims, end pieces or lens of eyeglasses, comprising:
a.) a first-side member of core embodiment, preferably and referred to as outwardly facing side, comprising of an embellishment or designated location for an embellishment, and
b.) a second-side member of core embodiment, preferably and referred to as top side, or reversely bottom side, contiguous and perpendicular to the outwardly facing side of the core embodiment, and
c.) a third-side member of core embodiment, preferably and referred to as inwardly facing side of the core embodiment, contiguous and perpendicular to the top side, wherein together with (b.) top or bottom side and (a.) outwardly facing side, embodiment substantially resembles a “U” shape and inwardly facing side comprises one, or more than one, inward curve or outward curve, or both substantially resembling an “S” curve.

3. All of the claims as described in claim 1, and claim 2, and
a spring hinge or tension hinge contiguous to the inwardly facing side or conjoining the top side or bottom side with the inwardly facing side or outwardly facing side.

4. All of the claims as described in claim 1, and claim 2, and claim 3, and
a protective surface or coating providing barrier between the eyewear and accessory core embodiment, integrated or non-integrated, comprising of rubber, vinyl or any other suitable material.

5. All of the claims as described in claim 1, and claim 2, and claim 3, and claim 4, and
all surface sides may be solid or semi-solid.

6. The claims as described in claim 1, and claim 2, and claim 3, and claim 4 and claim 5, and
composition of core embodiments and embellishments comprises of materials commonly used in articles of jewelry including metals such as silver, gold, steel and others, stones including natural or synthetic, enamels, beads, crystals, glass, plastics, leather or any other suitable material.
